(19) United States
(12) Patent Application Publication
(10) Pub. No.: US 2017/0011644 A1
(43) Pub. Date: Jan. 12, 2017

(54) Collaborative Knowledge Exchange System

(71) Applicant: Gary Isse, Pasadena, CA (US)

(72) Inventor: Gary Isse, Pasadena, CA (US)

(21) Appl. No.: 14/361,867

(22) PCT Filed: Apr. 22, 2014
(86) PCT No.: PCT/US14/34978

§ 371 Date: May 30, 2014

Related U.S. Application Data
(60) Provisional application No. 61/975,261, filed on Apr. 4, 2014.

(51) Int. Cl. G09B 5/06; G06Q 30/06; G09B 7/00; G06F 17/30

(52) U.S. Cl. CPC G09B 5/065; G06F 17/30598; G06Q 30/0601; G06F 17/30424; G09B 7/00

(57) ABSTRACT

A system includes an Internet connected server coupled to a data repository and having a processor executing software from a non-transitory medium, the software providing an interactive web site accessible by users executing a browser application, the web site enabling the users to upload and store relatively short core lesson files, each lesson file having a descriptive name, organization of the core lesson files into categories of subject matter, a mechanism enabling the users to add media files associated with individual ones of the core lesson files, and a mechanism enabling the users to find the core lesson files and associated media files by the categories of subject matter, and to interact with the core lesson files and associated media files.

### CROSS-REFERENCE TO RELATED APPLICATIONS

The present application claims priority to U.S. Provisional Patent Application 61/975,261 filed on 4 Apr. 2014, and all disclosure in the priority application is incorporated herein at least by reference.

### BACKGROUND OF THE INVENTION

1. Field of the Invention

The present invention is in the technical area of Internet-connected systems, and pertains more particularly to a system providing collaboration in learning, researching, studying, practicing, and information gathering.

2. Description of Related Art

A great variety of educational systems are known in the Internet world, and to the present inventor's knowledge all have a common defect. That defect being presentation material that is far longer than the usual attention span of most people who might benefit from material presented. Another common defect among such systems is a lack of collaborative enablement. That is, the person visiting to learn is not provided an experience in which he or she may participate fully, and may contribute to the material presented.

The advance of the Internet and World Wide Web has transformed the way people exchange knowledge. Knowledge contents available in the World Wide Web represent massive resources that allow people to tap into each other's expertise. In the pre-Internet era, knowledge exchange was localized and people were dependent on local and personal interactions among their learning network. In today's Internet era any and every knowledge is just a mouse click away. Existing platforms used for knowledge sharing and exchange in the World Wide Web include web portals, social networks, You Tube, web search engines, video sharing websites and more. These platforms do not present knowledge contents from diverse sources in a unified and user-friendly manner and do not permit users to customize or expand the knowledge content base. Using these platforms to search for knowledge contents on a specific subject is challenged by everything from cumbersome information access and unpredictable relevant search results. Existing platforms also do not provide comprehensive methodology for communication among users with similar interests. They only support knowledge contents created in some multimedia format and only support certain platforms and devices. Hence, there is a need for a comprehensive, intelligent, and collaborative knowledge exchange system supporting multiple formats, platforms, and devices, replete with a highly customized functionality and underlying taxonomy that would simplify access, improve search, and streamline content management with a consistent user interface.

### BRIEF SUMMARY OF THE INVENTION

In one embodiment of the invention a system is provided comprising an Internet connected server coupled to a data repository and having a processor executing software from a non-transitory medium. The software provides an interactive web site accessible by users executing a browser application, the web site enabling the users to upload and store relatively short core lesson files, each lesson file having a descriptive name, organization of the core lesson files into categories of subject matter, a mechanism enabling the users to add media files and associate the added media files with individual ones of the core lesson files, and a mechanism enabling the users to find the core lesson files and associated media files by the categories of subject matter, and to interact with the core lesson files and associated media files.

In one embodiment of the system the associated media files comprise one or more of quizzes or tests covering subject matter treated in the core lesson file, homework specific to the subject matter treated in the core lesson files, samples of subject matter treated in the core lesson files, supplemental reading suggestions, podcasts related to the core lesson files, and case studies related to the core lesson files. Also in one embodiment the software further provides a mechanism enabling a user to organize one or more lesson files and associated media files into an interactive classroom, the classroom enabling users to interact with the core lesson files and associated media files in the classroom. Also in one embodiment preprogrammed lesson plans are provided, and users may select among different lesson plans and follow preprogrammed sequences of activity in interacting with the core lesson files and associated media files.

In one embodiment of the system the software further provides registration of users as members, creation of personal profiles for members, and recordation of member's activities with the system, the records of activities accessible through the profiles. Also in one embodiment the system awards points for specific activities of members according to preset rules. Still in one embodiment point totals for members are displayed on a leaderboard for view by other members.

In one embodiment charges are made to interact with individual ones of the core lesson files, and members may purchase credit in the system to be used to pay fees for interaction. Also in one embodiment public or private enterprises or government organizations are registered as members, and users representing the enterprises or organizations are treated in the system as members. And still in one embodiment job search and placement functions are provided for the public or private enterprises and government organizations.

In another aspect of the invention a method is provided comprising steps of (a) providing, by an educational enterprise, an Internet-connected server coupled to a data repository and having a processor executing software from a non-transitory medium, the software providing an interactive web site accessible by users executing a browser application, the web site enabling the users to upload and store relatively short core lesson files, each lesson file having a descriptive name; (b) organizing the core lesson files into categories of subject matter; (c) enabling the users to add media files and associate the added files with individual ones of the core lesson files; and (d) enabling the users to find the core lesson files and associated media files by the categories of subject matter, and to interact with the core lesson files and associated media files.

In one embodiment of the method the associated media files comprise one or more of quizzes or tests covering subject matter treated in the media lesson, homework specific to the subject matter treated in the media lesson, samples of subject matter treated in the core lesson file, supplemental reading suggestions, podcasts related to the core lesson file, and case studies related to the core lesson file. Also in one embodiment the software further provides a mechanism enabling a user to organize one or more core lesson files and associated media files into an interactive classroom, the classroom enabling users to interact with the core lesson files and associated media files in the classroom. Also in one embodiment preprogrammed lesson plans are provided, and users may select among different lesson plans and follow preprogrammed sequences of activity in interacting with the core media files and associated media files. Still in one embodiment the software further provides registration of users as members, creation of personal profiles for members, and recordation of member's activities with the system, the records of activities accessible through the profiles.

In one embodiment of the method the system awards points for specific activities of members according to preset rules. Also in one embodiment point totals for members are displayed on a leaderboard for view by other members. Also in one embodiment charges are made to interact with individual ones of the media lessons, and wherein members may purchase credit in the system to be used to pay fees for interaction. Still in one embodiment public or private enterprises or government organizations are registered as members, and users representing the enterprises or organizations are treated in the system as members. And in one embodiment job search and placement functions are provided for the public or private enterprises and government organizations.

### BRIEF DESCRIPTION OF THE SEVERAL VIEWS OF THE DRAWINGS

FIG. 1 is an architectural diagram of a collaborative knowledge exchange system according to an embodiment of the invention.

FIG. 2 is an exemplary screen shot of a home page in an embodiment of the invention.

FIG. 3 is an exemplary registration window in an embodiment of the invention.

FIG. 4 is an exemplary profile for a member in an embodiment of the invention.

FIG. 5 is an exemplary personalized page displaying a core instruction file in an embodiment of the invention.

FIG. 6 is an exemplary window for posting a feedback in an embodiment of the invention.

FIG. 7 is an exemplary window for posting a core instruction file to the system in an embodiment of the invention.

FIG. 8 is an exemplary window for posting an associated file to the system in an embodiment of the invention.

FIG. 9 is an example of a classroom in an embodiment of the invention.

### DETAILED DESCRIPTION OF THE INVENTION

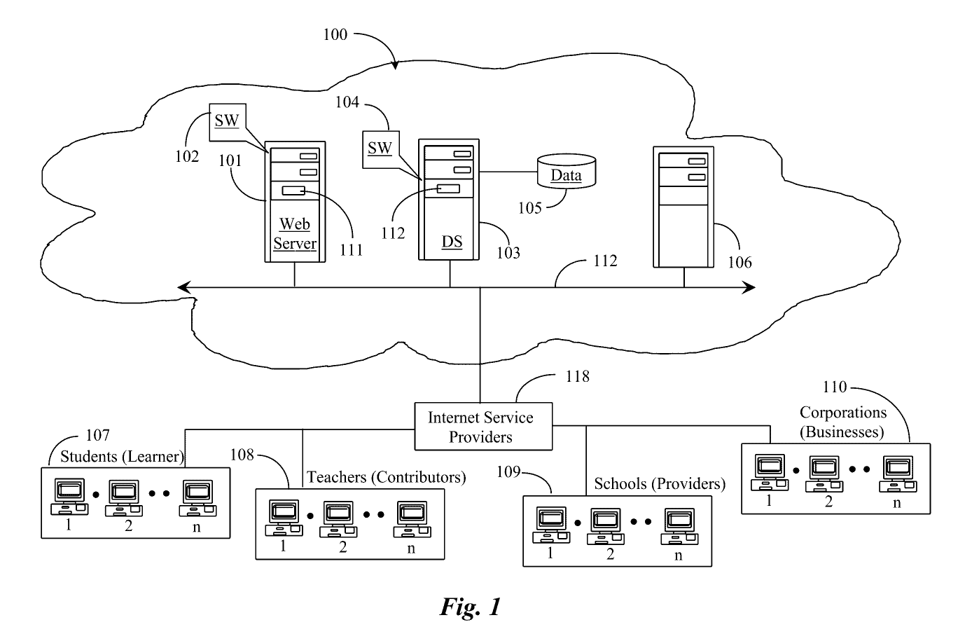

FIG. 1 illustrates architecture in one embodiment of a collaborative knowledge exchange system. The collaborative knowledge exchange system in this embodiment comprises a collaborative knowledge exchange platform implemented in the well-known Internet network 100, and a plurality of users compromising, in this example, students (learners) 107, teachers (contributors) 108, schools (providers) 109 and Corporations (businesses) 110, communicatively coupled via an Internet Service Provider 118.

The users exemplified as using computerized appliances in groups 107 through 110 may be using any sort of appliance that is capable of Internet connection and interaction, typically with a Browser application, with the cloud-based knowledge system in embodiments of the invention. Furthermore, the users depicted in groups 107 through 110, although some may represent businesses, some may be teachers, and some may be persons seeking to learn new skills, for example, may be just about anyone with access to an Internet-connected computer. The user's role is further defined by the system, as is described in enabling detail below.

The collaborative knowledge exchange platform in one embodiment comprises a web server 101 having a processor 111 executing software suite 102, a data server 103 having a processor 112 executing software 104 coupled with a database storage memory 105 communicatively coupled via Internet backbone 112, representing all of the myriad connections and interconnections in the Internet network as a whole. A third party server 106 is shown to represent other sites in the Internet that may or may not be used in practice of the present invention. Web server 101 and data server 103 may be computerized appliances comprising components such as a processor, memory, network interface, local storage medium, and other well-known components. Web server software 102 and data server software 104 are in one embodiment computer-executable program instructions executed from a non-transitory computer-readable storage medium. Database storage memory 105 can be physical local storage mediums such as local hard disks, hard drives and processor random access memory. Web server 101 and web server software 102 provide communication functions to interface with Internet Service Providers 118 and users, including, but not limited to, delivering web pages, user authentication, registration, payment, and account maintenance.

Data server 103, data server software 104, and database storage memory 105 provide data management related functions, including, but not limited to, data storage, data retrieval, data classification, and searches. In operation the collaborative knowledge exchange platform may lack components described herein or distribute the described functionality among the components in a different manner. Additionally, the functionalities attributed to more than one component may be incorporated into a single component.

Internet Service Provider 118 is meant to represent all the ways known in the art that Internet service may be provided. The method of communication between the collaborative knowledge exchange platform 100 and users is not limited to any particular user interface or network protocol.

In various embodiment of the invention the system may be described as a large and growing collection of core digital lesson files, sometimes termed Nuggets by the inventor partly because these files are deliberately kept short, both to conserve bandwidth, and to avoid over running a user's attention span. The inventor believes that most learning process is by acquiring knowledge or skill in short increments. The core files in the system may be accessed and played by individual users as educational and training material. The core files (Nuggets) may be in any format that may be presented, including, but not limited to, video, embedded video from a URL link, images, such as pictures in any known protocol, text documents, html docs, PowerPoint presentations, and more. These files are stored in data repository 105 in one embodiment, and may be stored in any repository that may be accessed by server 101 to present to users connected with a browser.

The core files that are instructive material in one embodiment are tagged and cross-referenced, and are organized in the system into categories. There is no limit to the categories in the system, which are maintained to aid users in finding core instruction files in just the right technical area. There may be many other files, often termed Nugglets by the inventor, that may be closely associated with Nuggets. Creators of these associated files, or in many instances other persons, may add associated files. The associated files may be, but are not limited to, any one of the following:

1. Quizzes

2. Homework

3. Samples

4. Instruction file Description

5. Supplemental Reading

6. Podcasts

7. Prerequisites for a course

8. Action Plan

9. Case Studies

10. Examples

11. Events, both in the system and remote

12. References followed in course material

The names Nuggets and Nugglets have no real bearing on limitations in the invention, and are simply descriptive connotations.

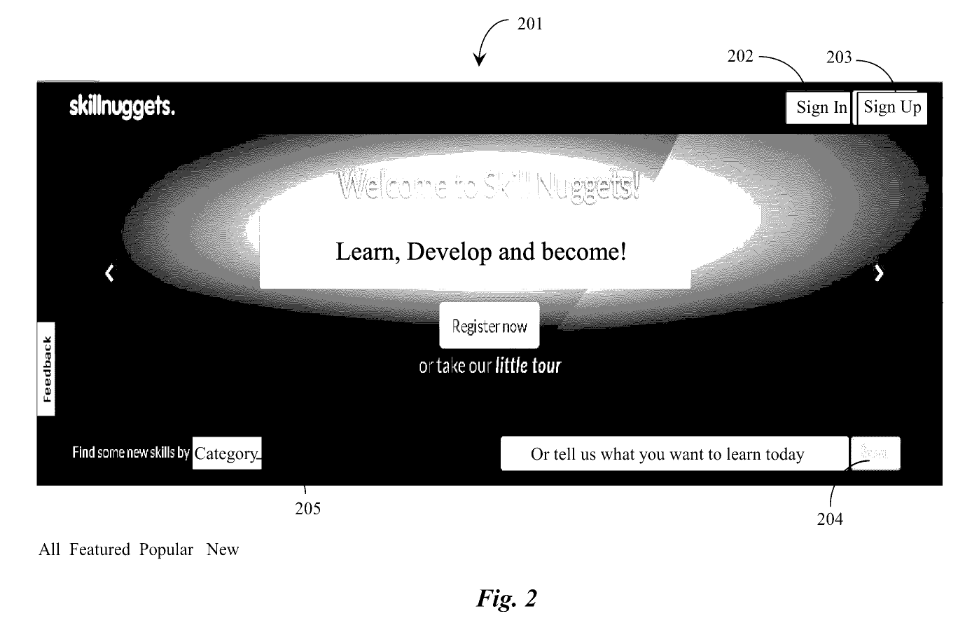

The system in the present invention in one embodiment is presented as a Web site through SW 102 executing on server 101. FIG. 2 is an exemplary interactive home page 201 that a user may see upon asserting a URL for the home page of the collaborative system in an embodiment of the invention. The user is welcomed to the site and asked to choose to register or to take a tour of the site. The tour explains the structure and use of the site. If the person accessing the home page is already a member of the collaborative learning system, he or she may select button 202 to sign in, which will display a sign in window asking for a username and a password, as is well-known in the art. If the person is not a registered member, that person may select the button “Sign Up” to access a window for becoming a registered user.

On the home page in this embodiment there is further a button 205 that will access a catalog of lesson material gathered in specific categories. Categories may be quite comprehensive, and the catalog may be multi-level enabling a user to start at a broad category, and drill down to successively more specific content. For example at a high level a user may choose “music”, then at a next level “instrument training”, then a particular instrument, like “piano”. There may be in some categories, like mathematics, for example, where the hierarchical levels may be more extensive. On the home page there is also a site search function 204 with an entry field, enabling a visitor to search the site for particular subject matter or topic.

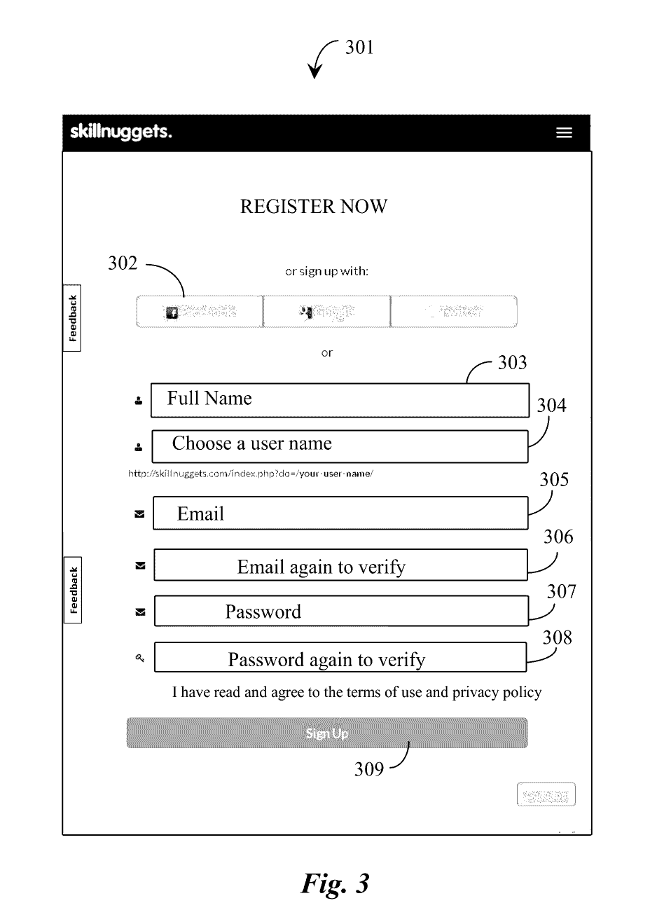

If the visitor is not yet registered and has determined to register, selecting “Sign Up” will navigate to a registration page. FIG. 3 illustrates a registration page 301 in one embodiment of the invention. A person may register through Facebook™, Google™ or Twitter™ at 302. Otherwise field 303 may be used to enter a full name, field 304 o choose a username, Fields 305 and 306 to enter and verify an email address, and fields 307 and 308 to enter and verify a password. After entry the user may select the “Sign Up” button and become a registered member.

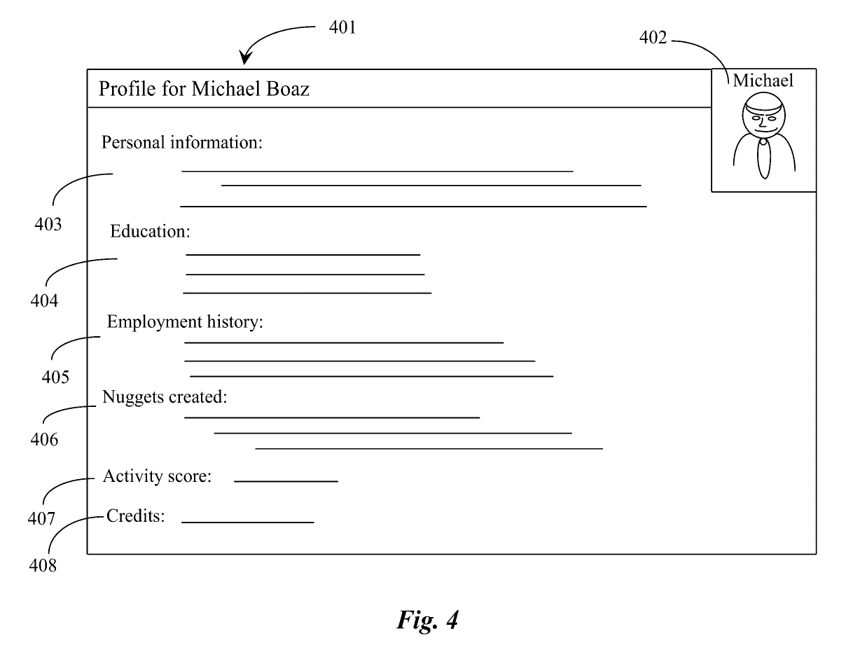

Once a person registers, a personal profile is created for the new member. Every member has a profile, and that profile stores the member's contact information and name, as well as history of activities in the system, personal preferences, and the like. FIG. 4 represents a profile for a particular person. Typically the member will be asked for a picture 402, which may be posted in the profile. In some embodiments the member may post a short video. The member may also fill out the profile with personal information 403, education 404, employment history 405, a list of files created 406, which may be automatically updated by the system, and the like, but no further personal information is required beyond name, username, password. The system keeps a record in each member's profile of activities, and updates an activity score, which is based on the user's activity in the system as a teacher, in creating core files, in completing course, in referring others to the system and much more.

A credit record is also kept in the user's profile, or in some cases elsewhere in the system. Credits may be purchased and used to pay fees and buy products in the system. There is a n interface accessible through a menu on a page that enables a member to check their credit, and to purchase credit as needed. The credit is maintained for each member, and each time a member buys credit or spends credit, the system adjusts the member's balance and posts the balance in the member's profile, and may make the accounting visible to the member in other ways.

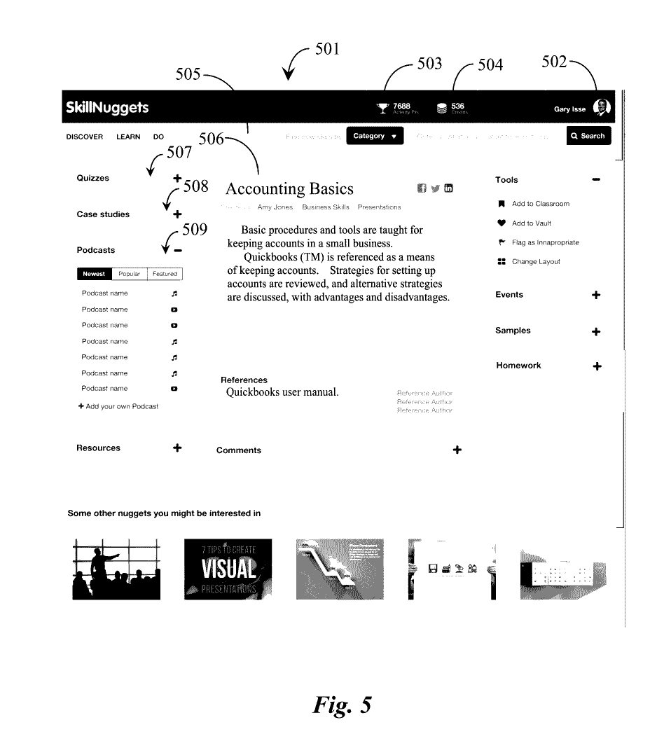

FIG. 5 illustrates a page 501 in an embodiment of the invention, the page personalized to member Gary Isse. Gary's picture 502 appears in the upper right, and Gary's Activity Score 503 and Credits 504 are shown in an upper bar. A menu bar 505 provides links to other pages enabling the user to discover other attributes of the system, to find other ways to learn, and to do various activities. There is a link for finding new skills to master by category, described above, and a field and button to search the site, also described above.

In this particular circumstance Gary has apparently selected a core lesson file (Nugget) through a search or through the hierarchy accessible by category, and the particular core lesson file selected is represented by box 506. The title is listed at the top, and in this instance the title is “Accounting Basics”. The creator is shown as Amy Fisher, and her name is a link that a user may assert to see a profile of Amy Fisher. There are links as well to “Business Skills” as a category, where the user may review other resources in this category. A general description is provided for the core lesson file describing the general purpose and content of this core lesson file.

There may also be any one or more of associated files, associated with the core lesson file 506.

Associated files may be any one of:

1. Quizzes

2. Homework

3. Samples

4. Core file Description

5. Supplemental Reading

6. Podcasts

7. Prerequisites for a course

8. Action Plan

9. Case Studies

10. Examples

11. Events, both in the system and remote

12. References followed in course material . . . as previously described above.

There are links on this top page for accessing individual ones of the associated files. For example, in the left pane of the page there are drop-down menus, such as at 507, where a user may access Quizzes, Case studies (508) and Podcasts (509). On a right panel in the page are links for Tools, Events, Samples and Homework. A drop-down menu is provided for a user to review comments made about this lesson file, and the user may make and enter comments as well.

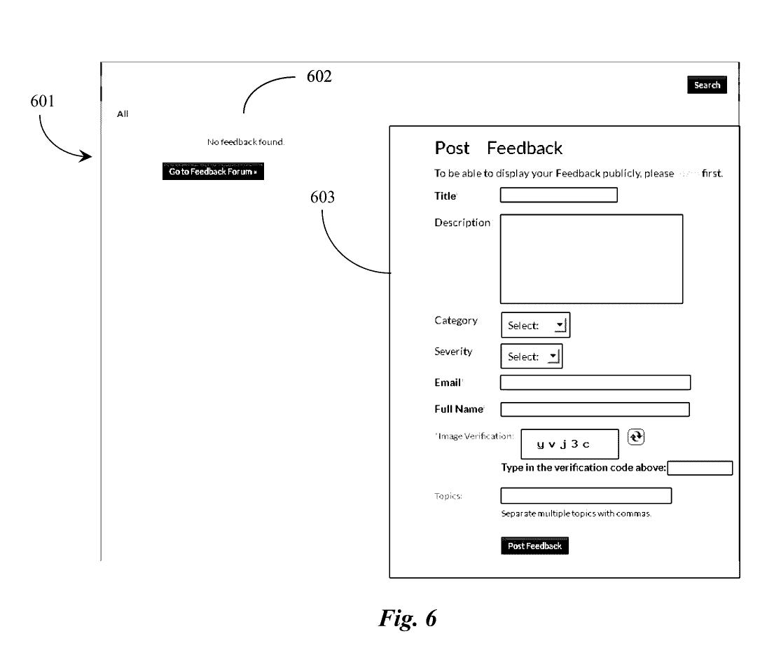

On most pages in the system, typically as a tab on one side of the page or the other, there is a link for posting feedback. FIG. 6 is an example of a window 601 that appears when the “feedback” link is selected. There is in the window a command line 602 for navigating to various feedback categories, and a window 603 for configuring and posting a feedback to the system.

An important purpose of the system is to provide an open forum where persons may share their own expertise and knowledge with the rest of the World. An important feature, then, is an ability in the system for persons to contribute instructional material as core files. Further to just contributing the core files, there is a procedure and tools for a member that qualifies to organize a classroom around a particular theme or skill, and to create a preferred study program for other users to follow in acquiring knowledge and skill through reviewing core files, and files associated with the core files.

To contribute core files, a person must be a member of the system, and must also meet certain minimum requirements, which may differ in different categories of learning. For example, to post core files for teaching violin, and to create a classroom around core files for that purpose and associated files related to teaching violin, the potential teacher/instructor must in some implementations, at a minimum, be able to demonstrate the he/she is capable in playing violin.

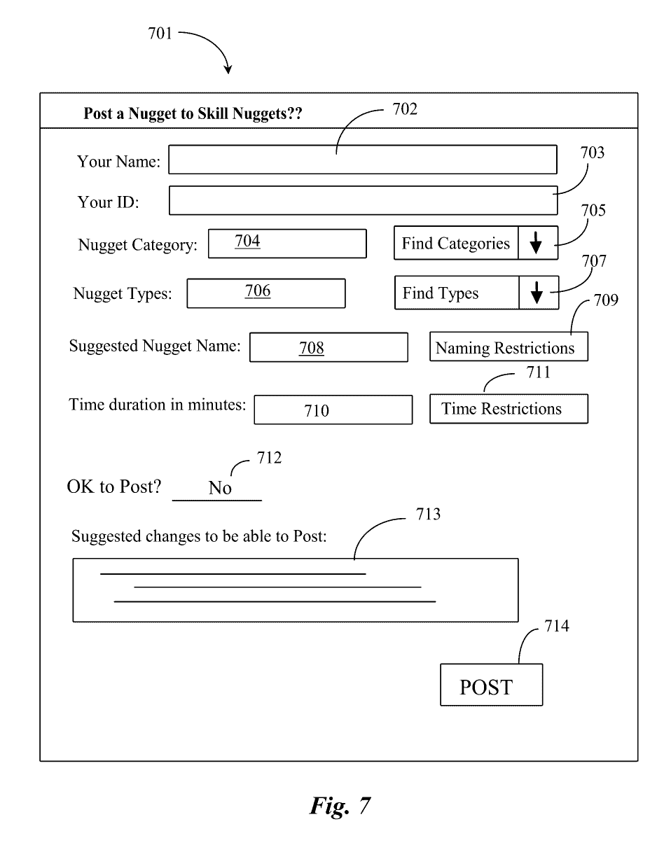

FIG. 7 is an exemplary window 701 embodying a tool for a member to post a core instruction file to the system. This window may be accessed in any one of several ways in the system, such as by a drop-down tools menu that may be displayed on any interactive page presented in the system site.

Window 701 provides a procedure for a member to post a core instruction file to the system. Fields 702 and 703 are to identify the member to the system. Not every member may be authorized to post a core file, and if the system checks, the member may see another window to the effect that he or she is not authorized to post, and may also explain how to become authorized.

If the member is authorized to post a core file, then the member may select a category by use of drop-down 705, and enter the correct category in field 704. The member may also review file types (video, PowerPoint, etc.) in drop-down 707, and enter the correct type in field 706. The member may enter a name for the core file in field 708. There will typically be name restrictions, such as length and other restrictions, and if the name entered violates such restriction a pop-up may notify the member how to correct. The member may post a time duration for the core file in field 710, and may review time by initiating link 711. A very important feature of the invention is that durations for viewing core files are intentionally kept short, partly to avoid going past a user's attention span. This is not to say that all core files are held to a same time standard. Time restrictions may vary over different file categories, but typically no core file will be of a duration longer than about ten minutes, although in many implementations of the invention this is not a strict constraint. However, in some embodiments there may be strict constraints for either or both of core lesson files and associated files to core lesson files.

At location 712 the system maintains a Yes/No display of whether the core file being proposed is OK to post. When all conditions are met, the display at 712 changes to Yes, and the member may post the file by selecting button 714, which will initiate a sequence enabling the member to upload the core file to the system.

Associated files, as described above, are additional material that may be associated with core files. These associated files may be provided to the system by teachers or by students, essentially any member. A teacher may upload and associate associated files with a core file in the process of providing a core file for students to use. The associated files may include, as described above, quizzes, homework, samples, supplemental reading, podcasts, pre-requisites, action plans, case studies, examples, events, references, discussion questions, links. Some file types, such as podcasts and case studies, may be provided by any members after having reviewed the core file.

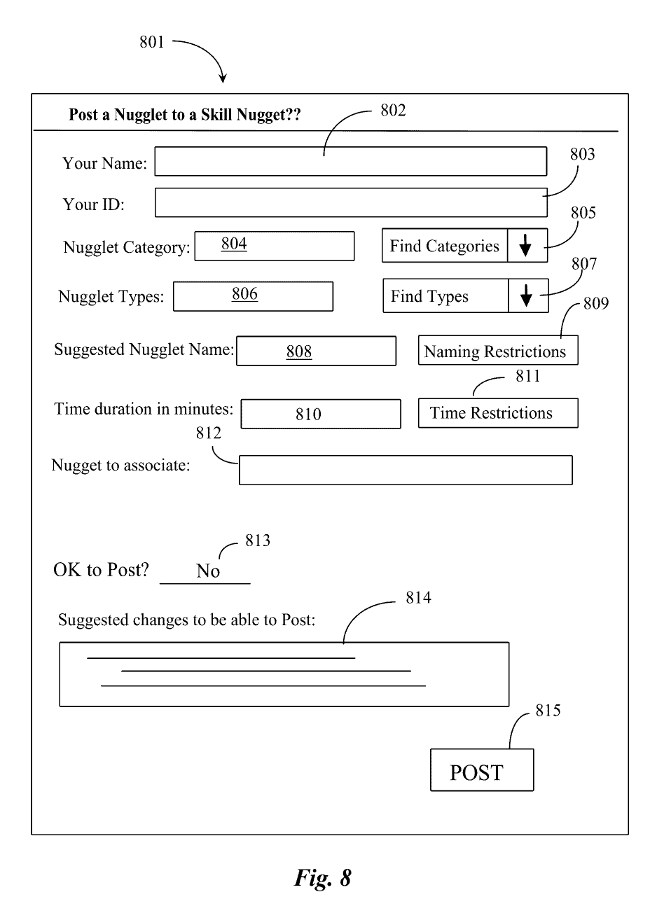

FIG. 8 is a window 801 enabling a member to upload an associated file in the system. This form is quite similar to the form for posting a core file. Fields 802 and 803 identify the member. Associated file category may be determined at 805 and entered at field 806. The associated file may be named in field 808 and naming restrictions may be reviewed by initiating link 809. Time for the associated file may be entered at field 810, and time restrictions reviewed through link 811.

Every associated file must be associated with a core file, so the core file name has to be entered in field 812. In some cases a member may be enabled to browse for the core file for association. When the associated file is approved to post the display 813 will change to YES, and the member may select button 815, which will start a procedure for the member to upload the material that comprises the associated file.

Another very important feature in the present invention is a Classroom, which is place to organize core files and associated files for a student to access and interface. Classrooms are created by members, primarily teachers, but may also be other members. A classroom is a mini web site in one embodiment of the invention. Typically a teacher, in posting one or more core files, may elect to create a classroom. A link to navigate to the classroom-creation site may be displayed on any one of the system web pages.

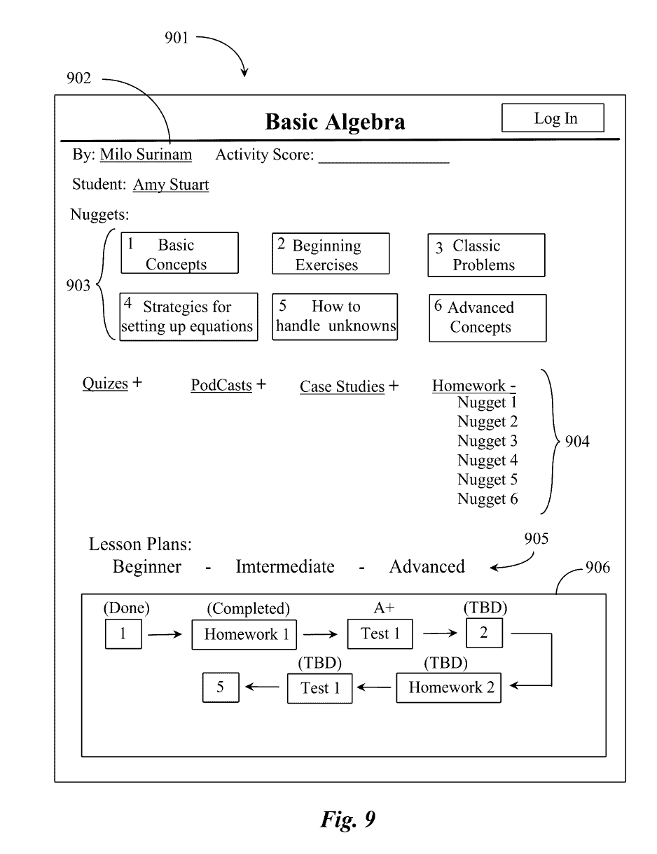

FIG. 9 is an exemplary format of a classroom 901 in an embodiment of the invention, created by Milo Surinam, a teacher who has three other classrooms in the system. Teacher Milo's name 902 is a link to a teacher profile for Milo, which displays Milo's credentials as a mathematician and as a teacher, and may show his academic credentials.

In this exemplary classroom a student Amy Stuart has logged in, and having logged in the page is now personalized to student Amy Stuart. In the Log-in process, which is additional to logging in to the system in this example, Ms. Stuart may be asked to pay for viewing one or more core lesson files in the classroom, which she may pay with credits previously purchased.

The core instruction files in this classroom, created by teacher Milo, are displayed as files 903, and are numbered in this example from 1 to 6. The name of each core file is displayed. Student Amy may, in one implementation of the invention select core files to review in any order, whether or not she has viewed a same core file previously. The system makes record of student Amy's behavior in the classroom, and history may be kept in the classroom, and perhaps may be mirrored to Amy's personal profile.

In another implementation of the invention the student may be constrained to follow core files in a particular sequence, which may apply to all of the core files in the classroom, or to individual groupings of core files.

Associated files 904 are likewise in this embodiment displayed as drop-down lists, each listing being a link to the associated file. Homework associated files are displayed, and Amy may select any one to work on the homework or review previously finished homework. Interactivity with other associated files is similar.

So Amy may study in a free-lance style by selecting core files and associated files, or may choose a pre-arranged progression 905, set by teacher Milo. In this example Amy has previously elected a beginner lesson plan, which is now displayed in display 906. In the display it is shown that Amy has completed core file 1, the homework assigned for core file 1, and Test for core file 1, for which she was awarded an “A” grade. She has not yet reviewed core file 2, and following tasks are to-be-done (TBD). In some embodiments of the invention this classroom may be linked to other classrooms, and is also associated and listed in categories for browsing student members to select and navigate to content of their choice.

Typically, in the nature of the invention in many embodiments, a classroom will be constrained in content and time, just as are core lesson files. For example, there may not exist a classroom in the system for teaching violin, from rank beginner to virtuoso. There may, however, be a series of classrooms, a first for instructing about bow, instrument and tuning, then a second for first sounds from the violin, then a third teaching beginning musical lessons, and so on through a long series of short classrooms that a student may follow to become, hopefully, in the end, a virtuoso on the violin.

In some embodiments classrooms may have their own Discussion Forums independently of associated files, and Classrooms may have independent Comment mechanisms independent of the associated files. A different between Forums and Comments in some embodiments is that forums in some embodiments are available only to Members of the Classrooms while comments may be posted by anyone. In some embodiments the classroom is the lesson plan. It is in these embodiments a real-world, interactive, lesson plan. Also in some embodiments there may be no choice between different levels or lesson plans. The classroom is the plan. If someone is in “Beginner” and they'd like to go to “Intermediate” that would be a different Classroom in these embodiments.

In some embodiments lessons may be presented live. In this case members may be notified in advance by teachers presenting live lessons, and arrangements may be made to pay for attendance in advance. In some cases there will be a requirement for a minimum number of attendees to present a live lesson, and payments may be held until the threshold is met before being processed, so no one may be charged for a lesson that does not occur. A procedure is provided in some embodiments for teachers to promote lessons, whether live or not, to members by email or text, for example.

The system in some embodiments offers pseudo live support for recorded lessons, by allowing live chat. For example, the teacher could announce that there will be a live chat session at a certain time such that students can submit issues and get immediate answers from the teacher. Both student and teacher may communicate by text, audio or video in any combination.

It is important to note that many features of the invention in different implementations are especially suited to interfacing with persons wishing to acquire skills, and using mobile devices, think smartphones and pad devices, typically lighter in computer power that fixed and portable computers. The limitation of core files and associated files in the system to typically short time duration also conserves bandwidth, important for interfacing with mobile devices.

In one implementation of the invention a user accessing the system with a mobile device may download an application enabling that person to download certain content, at least temporarily, and work offline. Then, after an offline session the user might re-connect to the system and upload his or her results and activity (think, for example, homework) and continue on a course to acquire skill and knowledge.

In some embodiments of the invention forums may be organized, and members may be advised of times and subject matter, and attendees may be displayed for others to review. Members may propose and organize forums, under review by the system, and members may post questions and problems in forums for immediate answer.

In embodiments of the invention a comprehensive search procedure is enabled, allowing members and non-members in many cases, to search the database by teacher, by subject matter, by category, by existence of classrooms, by core files, and so on. Members may bookmark content, priming the system to remind them of their interest in certain subject matter.

In some embodiments members may refer others to the system, and in registering, potential members may credit members for referral. In a successful referral a referring member may be awarded activity pints, or in some cases credit in the system.

Activity points is a process for rewarding and recognizing members for their activity on behalf of themselves and on behalf of the system. A member who completes a course may be awarded a predetermined number of activity points. Points may be awarded for successful referrals. Points may be awarded in a sliding scale for grades on tests associated with core files in the system. Points may be awarded to teachers for creating new classrooms and the like. There may be in some embodiments a “Leaderboard” displaying the highest scoring members in activity points. Other rewards may be made as well, to encourage members to make good use of the system.

There may be in some embodiments an internal communication system wherein members may freely associate and freely communicate in any one of several formats, such as email, chat, SMS, and the like. With permission, the system may post external email addresses and telephone numbers for interaction among members. Further members may be enabled to make payments within the system by PayPal, Alipay and UnionPay.

In some embodiments teachers in the system may post their profiles through Social Networks such as FaceBook™, Twitter™ and LinkedIn™. Members in the system may friend other members, and transfer contacts and friend status to FaceBook™ for example.

In some embodiments of the invention there may be a directory where enterprises, government agencies and schools, such as universities may post links to their own sites as a way of affiliating with the system. Likewise the system may post promotional material on other websites to apprise people of the availability of this on-line learning resource.

In one embodiment there will be a job posting a referral system wherein enterprises and government organizations may post positions to be filled, and receive applications from interested members. In some embodiments there may be facility for banner ads to be created and placed with core lesson files and in classrooms.

In one embodiment enterprises and government agencies may associate with the system to provide education for their own employees, who may be identified as members to be affiliated with these particular enterprises and government agencies. In this collaboration the associated entities may pay fees for their affiliated members as a group or in advance. Outside enterprises may also register as members and post a profile for use by other members. Enterprises may seek candidates for open positions according to skills learned in the system, and according to activity points. Enterprises as members may also develop classrooms to further their own needs to develop members to be future employees. In some cases positions may be advertised to members as requiring certain successful completion of a variety of course, and members may apply to become trainees for that enterprise, in which their progress toward completion of requirements and employment may be tracked.

It will be apparent to the skilled person that the descriptions of embodiments above are exemplary, and do not constitute limitations in scope of the invention. Many of the features of the invention as described may be provided in equivalent ways within the scope of the invention. The scope of the invention is limited only by the claims that follow.

1. A system comprising:
an Internet connected server coupled to a data repository and having a processor executing software from a non-transitory medium, the software providing:
an interactive web site accessible by users executing a browser application, the web site enabling the users to upload and store relatively short core lesson files, each lesson having a descriptive name;
organization of the core lesson files into categories of subject matter;
a mechanism enabling the users to add media files and associate those files with individual ones of the core lesson files; and
a mechanism enabling the users to find the core lesson files and associated media files by the categories of subject matter, and to interact with the media lessons and associated media files.

2. The system of claim 1 wherein the associated media files comprise one or more of quizzes or tests covering subject matter treated in the media lesson, homework specific to the subject matter treated in the media lesson, samples of subject matter treated in the media lesson, supplemental reading suggestions, podcasts related to the media lesson, and case studies related to the media lesson.

3. The system of claim 2 wherein the software further provides a mechanism enabling a user to organize one or more core lesson files and associated media files into an interactive classroom, the classroom enabling users to interact with the core lesson files and associated media files in the classroom.

4. The system of claim 3 wherein preprogrammed lesson plans are provided, and users may select among different lesson plans and follow preprogrammed sequences of activity in interacting with the core lesson files and associated media files.

5. The system of claim 3 wherein the software further provides registration of users as members, creation of personal profiles for members, and recordation of member's activities with the system, the records of activities accessible through the profiles.

6. The system of claim 5 wherein the system awards points for specific activities of members according to preset rules.

7. The system of claim 5 wherein point totals for members are displayed on a leaderboard for view by other members.

8. The system of claim 1 wherein charges are made to interact with individual ones of the core lesson files, and wherein members may purchase credit in the system to be used to pay fees for interaction.

9. The system of claim 5 wherein public or private enterprises or government organizations are registered as members, and users representing the enterprises or organizations are treated in the system as members.

10. The system of claim 9 wherein job search and placement functions are provided for the public or private enterprises and government organizations.

11. A method comprising steps:
(a) providing, by an educational enterprise, an Internet-connected server coupled to a data repository and having a processor executing software from a non-transitory medium, the software providing an interactive web site accessible by users executing a browser application, the web site enabling the users to upload and store relatively short core lesson files, each core lesson file having a descriptive name;
(b) organizing the core lesson files into categories of subject matter;
(c) enabling the users to add media files and associate individual ones of the added media files with individual ones of associated with individual ones of the core lesson files; and
(d) enabling the users to find the core lesson files and associated media files by the categories of subject matter, and to interact with the media lessons and associated media files.

12. The method of claim 11 wherein the associated media files comprise one or more of quizzes or tests covering subject matter treated in the core lesson file, homework specific to the subject matter treated in the core lesson file, samples of subject matter treated in the core lesson file, supplemental reading suggestions, podcasts related to the core lesson file, and case studies related to the core lesson file.

13. The method of claim 12 wherein the software further provides a mechanism enabling a user to organize one or more core lesson files and associated media files into an interactive classroom, the classroom enabling users to interact with the core lesson files and associated media files in the classroom.

14. The method of claim 13 wherein preprogrammed lesson plans are provided, and users may select among different lesson plans and follow preprogrammed sequences of activity in interacting with the core lesson files and associated media files.

15. The method of claim 13 wherein the software further provides registration of users as members, creation of personal profiles for members, and recordation of member's activities with the system, the records of activities accessible through the profiles.

16. The method of claim 15 wherein the system awards points for specific activities of members according to preset rules.

17. The method of claim 15 wherein point totals for members are displayed on a leaderboard for view by other members.

18. The method of claim 11 wherein charges are made to interact with individual ones of the core lesson files, and wherein members may purchase credit in the system to be used to pay fees for interaction.

19. The method of claim 15 wherein public or private enterprises or government organizations are registered as members, and users representing the enterprises or organizations are treated in the system as members.

20. The method of claim 19 wherein job search and placement functions are provided for the public or private enterprises and government organizations.
